(19) United States
(12) Patent Application Publication
(10) Pub. No.: US 2014/0303992 A1
(43) Pub. Date: Oct. 9, 2014

(54) SYSTEM AND METHOD OF ASSISTING PRESCRIPTION TREATMENT FULFILLMENT

(71) Applicant: CoverMyMeds, LLC, Columbus, OH (US)

(72) Inventors: Matthew A. Scantland, Upper Arlington, OH (US); Scott Carson Ziegler, Columbus, OH (US); Samuel M. Rajan, Hudson, OH (US); Ryan E. Sanders, Sugarloaf Key, FL (US); Alan J. Gilbert, Sunbury, OH (US); Patricia A. Yacovone-Biagi, Worthington, OH (US); Ron Fine, Gardendale, AL (US)

(73) Assignee: CoverMyMeds, LLC, Columbus, OH (US)

(21) Appl. No.: 14/244,082

(22) Filed: Apr. 3, 2014

Related U.S. Application Data
(60) Provisional application No. 61/807,893, filed on Apr. 3, 2013.

(51) Int. Cl. G06F 19/00

(52) U.S. Cl. CPC G06F 19/3456; G06F 19/328
USPC 705/2

(57) ABSTRACT

Provided is a method and system for facilitating limited fulfillment of a prescription for a drug. An indication that an authorizing party has rejected an insurance claim submitted by a pharmacy for insurance coverage of at least a portion of a purchase price of a prescription drug on behalf of a patient is received over a network, in addition to an indication that prior authorization is required. Before a decision whether to grant the prior authorization is issued by the authorizing party, initiating transmission of an offer to allow redemption of a quick start voucher to the pharmacy over the communication network that allows the limited fulfillment of the prescription for the prescription drug, but less than the complete fulfillment.

### CROSS-REFERENCE TO RELATED APPLICATIONS

This application claims the benefit of U.S. Provisional Application No. 61/807,893, filed Apr. 3, 2013, which is incorporated in its entirety herein by reference.

### BACKGROUND OF THE INVENTION

1. Field of the Invention

This application relates generally to a method and apparatus for assisting prescription treatment fulfillment and, more specifically, to a method and apparatus for alerting a user that prior authorization is required before a full prescription can be filled, and a method and apparatus for arranging a limited quantity of a prescription drug called for by the prescription to be dispensed before prior authorization is granted for complete fulfillment of the prescription.

2. Description of Related Art

When a prescription calling for a prescription drug or other restricted treatment to be dispensed for a patient is delivered to a pharmacy, the pharmacist enters relevant information concerning the drug, the patient, and any insurance coverage the patient may have into the pharmacy's computer system. This information is transmitted over the Internet to an insurance provider, a pharmacy benefits manager such as Medco Health Solutions, Inc., or another party, requesting the party to at least partially cover the cost of the prescription drug to be dispensed. If the transaction for the prescription drug is covered, notification is transmitted to the pharmacy and the insurance provider or other party will pay at least a portion, or optionally all of the purchase price of the prescription drug. The recipient will pay any balance due at the time the drug is dispensed. For such an approved pharmacy transaction, confirmation that at least part of the purchase price of the prescription drug is covered by an insurance provider can be automatically determined instantaneously at the time of sale and the prescription drug given to the recipient if the drug is covered by the patient's insurance plan.

Depending on the insurance coverage, however, it may not be possible to automatically determine when the request is submitted whether certain prescription drugs are covered by a patient's insurance plan. For example, expensive drugs, brand-name drugs with a generic available, drugs specifically excluded from a patient's medical insurance plan, drugs at unusually-high doses, etc., may ultimately be at least partially paid for by the insurance provider, but first require prior authorization from that insurance provider or other medical benefit provider before any portion of the cost can be allocated by the pharmacy to that insurance plan. Until such prior authorization is received, the patient has the following options: (i) forgo receiving the prescription drug altogether and await a decision on a request for prior authorization, (ii) settle for a different drug that is accepted as an alternative to the prescription drug and does not require prior authorization, if available, or (iii) pay the full amount for the prescribed drug out of pocket and optionally seek reimbursement after the fact.

Foregoing the prescription drug altogether may result in the delay of treatment of an ailment for which the prescription drug was prescribed in the first place. If allowing the ailment to go untreated poses a serious risk to the patient's health, foregoing the prescription drug may not be a viable option. There may also be no acceptable alternatives available for a proprietary drug, and paying out of pocket may not be practical due to the high cost of some prescription drugs and the uncertainty about whether the out of pocket expenses will be reimbursed.

### BRIEF SUMMARY OF THE INVENTION

According to one aspect, the subject application involves a method of allowing limited fulfillment of a prescription for a drug. The method includes receiving, with a computer and over a communication network, that an authorizing party has rejected an insurance claim submitted by a pharmacy for insurance coverage of at least a portion of a purchase price of a prescription drug on behalf of a patient. A communication indicating that the authorizing party requires prior authorization of the insurance coverage as a condition to complete fulfillment of the prescription, as prescribed by a physician licensed to practice medicine, is also received over the communication network. Before a decision whether to grant the prior authorization is available from the authorizing party, transmission of an offer to allow redemption of a quick start voucher to the pharmacy over the communication network that allows the limited fulfillment of the prescription for the prescription drug, but less than the complete fulfillment, is initiated to permit the pharmacy to dispense a quantity of the prescription drug to be administered to the patient before the decision the decision whether to grant the prior authorization is issued.

According to another aspect, the subject application involves a method of fulfilling a prescription for a drug. The method includes submitting an insurance claim with a computer, seeking at least partial insurance coverage of the drug under an insurance plan on behalf of a patient. An indication is received over a communication network that an authorizing party has rejected the insurance claim and requires prior authorization of the insurance coverage as a condition to the insurance coverage of a quantity of the drug to be dispensed in complete fulfillment of the prescription, as prescribed by a physician licensed to practice medicine. A communication is transmitted to a service provider computer over a communication network to indicate that the prior authorization has been required by the authorizing party. In response to transmitting this communication, and before receiving a decision concerning the prior authorization from the authorizing party, an offer comprising a quick start voucher is received over the communication network. The quick start voucher is redeemable for at least partial cost coverage of the prescription for the drug on behalf of the patient without the decision whether to grant the prior authorization from the authorizing party. In addition to communicating a decision to redeem the quick start voucher, prior authorization information that is to be included in a prior authorization request for submission with the authorizing party is transmitted over the communication network.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 shows an illustrative embodiment of a computer system for submitting a request for coverage of a prescription drug;

FIG. 2 shows an illustrative embodiment of a computer-generated interface of a claims system or point of sale system that receives script information and presents a result of a request for insurance coverage;

FIG. 3 shows an illustrative embodiment of a form selection interface that receives information pertaining to a drug and a state in which a patient resides to be used for selecting an appropriate prior authorization request form;

FIG. 4 shows an illustrative embodiment of a menu allowing a pharmacist to select an option to receive a Quick Start Voucher;

FIG. 5 shows an illustrative embodiment of a redemption window presenting a plurality of delivery options for a Quick Start Voucher; and

FIG. 6 shows a schematic representation of a messaging system for modifying a first message to include content selected by a computer system based on information included in an electronic communication transmitted as part of a process of fulfilling a prescribed treatment such as a drug.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

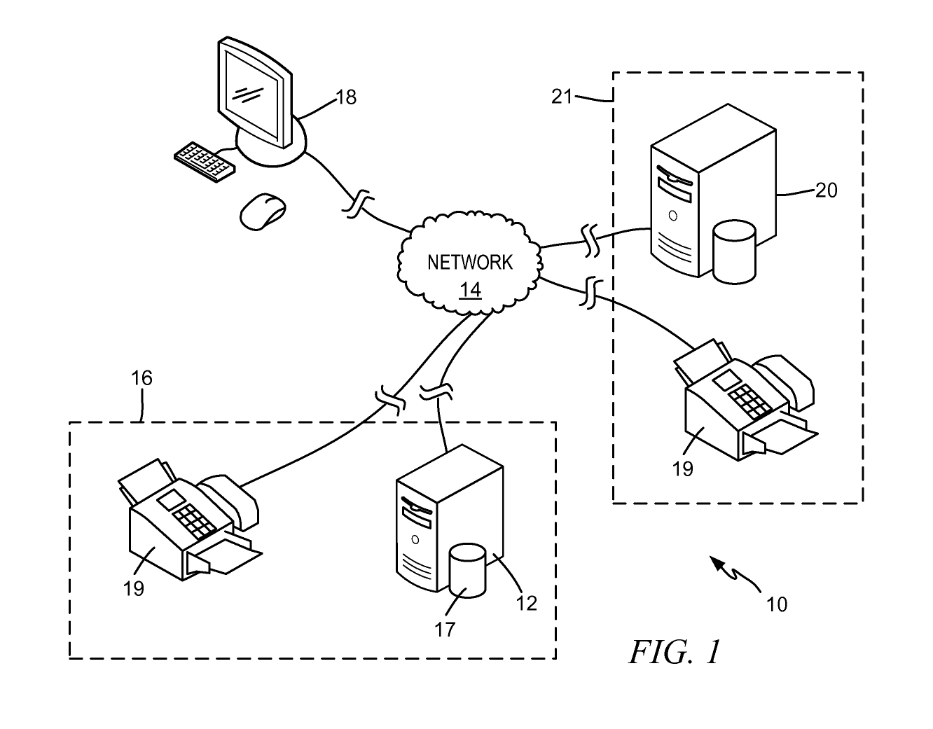

FIG. 1 shows an illustrative embodiment of a computer system 10 for submitting a request for coverage of a prescription drug. The computer system 10 can also optionally be configured to submit a request for prior authorization if so required by an insurance provider.

As shown, the computer system includes a service provider computer 12 operatively connected to communicate with other network-connected devices over a communication network 14, which can include a wide area network (“WAN”) such as the Internet, and optionally aspects of a local area network (“LAN”). According to alternate embodiments, the communication network 14 can also optionally include computer components and be programmed with proprietary software of a third party (e.g., a party other than, and independent of the pharmacy, service provider 16 and an Authorizing Party, which is described below. For example, the communication network 14 can include computer hardware and/or software that facilitates the submission and resolution of insurance claims to various different Authorizing Parties 21.

The service provider computer 12 includes a computer processor programmed to execute method steps performed on behalf of a service provider 16 to facilitate, and optionally act as an intermediary between a pharmacy submitting a request for prior authorization and an insurance provider, pharmacy benefits manager, or other party that is to render a decision on such a request (hereinafter referred to generically as an “Authorizing Party 21”) to which such a request for prior authorization is to be submitted. Prior authorization of the Authorizing Party 21 can be required for a variety of reasons (e.g., a drug other than that prescribed is available as a substitute—a “formulary alternative”, the patient's insurance plan limits have been exceeded, etc.). Regardless of the reason, prior authorization requires consideration of the prescription by the Authorizing Party 21 to approve the prescribed drug before the Authorizing Party 21 confirms that the patient's insurance plan will at least partially cover the cost of the prescribed drug. The service provider computer 12 can optionally be configured as a server to host information to be provided to, or otherwise utilized in communicating with a pharmacy terminal 18 located at a pharmacy filling a prescription for a prescription drug as described herein. A fax machine 19 can optionally be present at the service provider 16, or its functionality can be incorporated into the service provider computer 12 as a fax-modem component, for example. A similar device and/or functionality can also optionally reside with the Authorizing Party 21. According to alternate embodiments, the computer processor provided to the pharmacy terminal 18 can optionally be programmed to generate the displays and/or perform method steps described herein, optionally independently of the service provider computer 12. An Authorizing Party computer, which can optionally be configured and programmed as a server to host content retrieved over the communication network (hereinafter referred to as “server” 20) or other computer terminal associated with the Authorizing Party 21, which can be a pharmacy benefits manager or other party to which insurance coverage requests, and optionally prior authorization requests, can be submitted for authorization, is configured and operatively connected to communicate via the communications network 14 and receive a request for prior authorization for the prescription drug that is the subject of the prescription to be filled at the pharmacy operating the pharmacy terminal 18.

According to alternate embodiments, the communication network 14 can support a private and secure network connection such as dedicated dial-in number or static IP address requiring access credentials, restricting communications to those between the service provider computer 12 or other network-compatible computer or communication equipment affiliated with the service provider 16, which can optionally be a third party that is formally unrelated to the Authorizing Party 21 or the pharmacy submitting a request to the Authorizing Party 21, and such compatible equipment affiliated with the Authorizing Party 21. In other words, the service provider 16 can be a corporate or other business entity (e.g., limited liability corporation) not governed by the pharmacy and/or Authorizing Party 21 or controlled by a common entity, but has been contracted or otherwise utilized by a pharmacy and/or Authorizing Party 21 to facilitate prior authorization requests there between. The Authorizing Party 21 can transmit a notification over the communication network 14 in response to receiving a request transmitted by the pharmacy terminal 18, for example, indicating whether the prescribed treatment to be fulfilled is covered by an insurance plan.

Regardless of the configuration of the computer system 10, the present disclosure is directed toward a system and method that utilizes at least a portion of the computer system 10 to assist in the fulfillment of a prescription for a drug prescribed by a physician who is licensed to practice medicine by a state, country, or other governing body, and authorized to prescribe controlled substances. The processing component provided one of the computer terminals described herein executes computer-executable instructions stored on a non-transitory computer readable medium to carry out any of the method steps described herein. Although the system and method are described herein as assisting in the fulfillment of a prescription for a drug for the sake of clarity and brevity, the present method and system can be used to assist in the fulfillment of any order or request for a product and/or service pertaining to patient care. For example, a request of the Authorizing Party 21 to cover at least a portion of the payment for an injectable substance that does not require prior authorization can optionally be transmitted over the communication network 14. However, for the sake of brevity, the discussion below will involve providing the additional information to supplement an original message pertaining to a prescription drug only after a determination has been made by, or on behalf of the insurance provider and communication over the communication network 14 that prior authorization is required before at least partial coverage of the cost by the insurance provider is authorized.

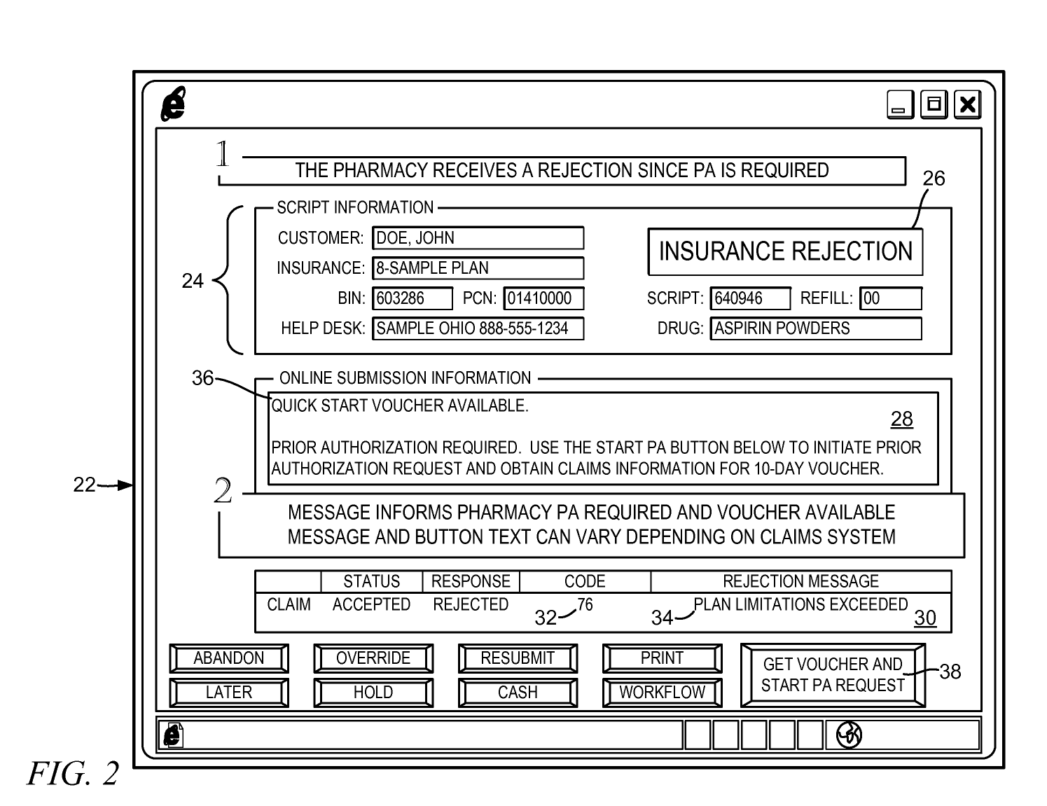

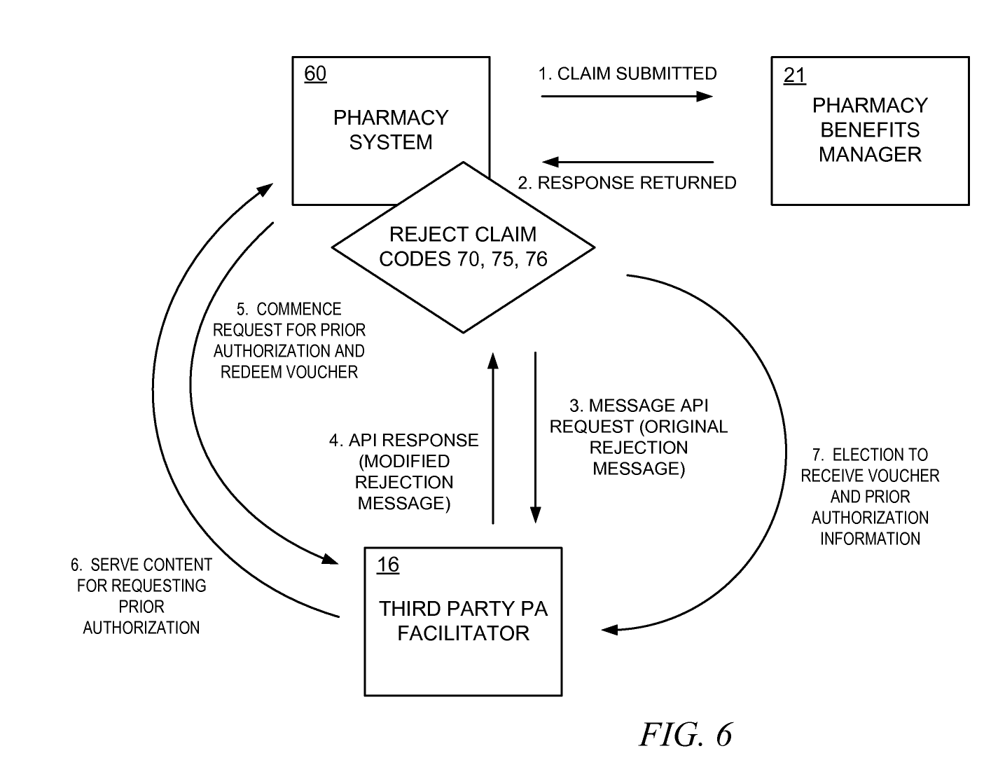

As shown in FIG. 2, and functionally described with reference to the block diagram of FIG. 6 illustrating an embodiment of the communication flow of the present system and method, when the prescription is submitted to the pharmacy (e.g., delivered manually by hand, transmitted electronically from a prescribing physician over the communication network 14, etc.) the pharmacist can use the pharmacy terminal 18 to generate a point of sale display 22. The point of sale display 22 can be presented by a pharmacy system 60 shown in FIG. 6, which can optionally be embodied as the pharmacy terminal 18 of FIG. 1, executing computer-executable instructions that cause the pharmacy terminal 18 to transmit “script information” to the server 20 over the communication network 14. The point of sale display 22 can be utilized during the actual sale of the prescription drug when legal tender is exchanged in payment for the prescription drug, or can be a separate terminal dedicated for submitting insurance claims. Regardless, the point of sale display 22 is designed to elicit information at the pharmacy that can be used by the pharmacy to determine the dollar amount of the prescription drug price that is to be paid out of pocket by the recipient of the prescription drug, if any. For example, the point of sale display 22 can include script information fields 24 that are populated with “script information” by the pharmacist with information pertaining to the patient (e.g., patient name, identification number, or any other information that can be utilized to convey the identity of the patient to the server 20), insurance plan (e.g., plan name, account number, etc.), drug (e.g., drug name, National Drug Code, or any other information that can be utilized to convey the identity of the drug, and optionally dose, in question to the server 20), and optionally additional information supplied by or on behalf of the patient. For example, a prescription number, a number of permissible refills called for by the prescription, and any other information pertinent to obtaining insurance coverage for at least a portion of the cost for a prescription drug can also optionally be included in the script information fields 24. A detailed description of a system and workflow for submitting a request for prior authorization can be found in U.S. patent application Ser. No. 13/413,231 to Scantland et al., which is incorporated in its entirety herein by reference.

Once the necessary script information has been entered into the point of sale display 22 presented by the pharmacy terminal 18, the script information is transmitted over the communication network 14 to the server 20 affiliated with the Authorizing Party 21 which, in the example shown in FIG. 6 is the pharmacy benefits manager, that hosts details concerning the scope of coverage offered by the patient's health insurance. The pharmacy benefits manager can optionally be associated with (e.g., a department of) the insurance provider, or an unaffiliated third party engaged in a business capacity to facilitate decisions on insurance coverage and/or prior authorization requests. In response, the server 20 can, automatically or with the involvement of a human operator, transmit a preliminary answer, based on the script information received, whether the patient's insurance plan covers the prescription drug. If it can be readily determined that the patient's insurance policy covers at least a portion of the prescription drug, the server 20 can transmit content indicative of the coverage and content that can be used by the pharmacy terminal 18 to present to the pharmacist the final out of pocket expenses owed by the recipient for the prescription drug, if any.

If, however, it is determined that the prescription drug will require prior authorization from the insurance provider or other party before it can be determined whether the recipient will receive any financial assistance for the prescription drug from the insurance provider, the server 20 can transmit content via the communications network that causes the pharmacy terminal 18 to present a rejection notice 26. In this example, the rejection notice 26 constitutes the phrase “Insurance Rejection”, but other suitable notices can be used instead of, or in addition to this phrase. This content is referred to herein as an original message from the Authorizing Party 21 indicating the decision and can be utilized by the pharmacy terminal 18 to inform the pharmacist of the Authorizing Party's decision. This content is referred to as an original message in that it originated at the Authorizing Party 21, and is transmitted there from with the information intended by the Authorizing Party 21 to be presented to the pharmacy system 60 as an initial decision on the originally-submitted request for insurance coverage of a portion of the prescription drug price. Collectively, the information included in the claim transmission from the pharmacy terminal 18 to the server 20, and the original message response, can include at least one of: the bank identification number (“BIN”), processor control number (“PCN”), group ID, pharmacy reject code, rejection message, prescription reference number and/or qualifier, product service identifier and/or qualifier, service provider identifier and/or qualifier, cardholder identifier, person code, and prescriber identifier and/or qualifier. Box “1” in FIG. 2 is indicative of receipt of the original message and the presentation of the context of the message to the pharmacist in this case, stating that the pharmacy has received a rejection and that prior authorization is required. Box “1”, along with the other numbered boxes appearing in the Figures forming part of the present application are not generated as part of the display by the pharmacy terminal 18 or other terminals described herein, but are included simply to annotate what appears in the Figures for the sake of clarity.

Also shown in FIG. 2 is an Online Submission Interface window 28 in which supplemental information and/or instructions for furthering the prescription process toward completion can be presented by the pharmacy terminal 18 to the pharmacist. For the embodiment appearing in FIG. 2, the Online Submission Interface window 28 indicates that insurance coverage for the prescription drug was rejected, and that prior authorization of any contribution toward the price of the prescription drug is required. A detail window 30 can also include a more-detailed breakdown of the reasons behind the rejection. For the embodiment in FIG. 2, the detail window 30 indicates that insurance claim received by the server 20 was accepted, but coverage was rejected. A Pharmacy Reject Code 32 representing a class in which the type of rejection falls and a detailed description 34 of the rejection are also provided. The Pharmacy Reject Code 32 can optionally be a standardized code promulgated by a government entity, trade or professional organization, or any other body as being standardized across a population of separate, unaffiliated users, instead of being proprietary and specific to different individual entities.

Although the original message notifies the pharmacist whether the insurance claim has been approved or requires prior authorization, the content included in the original message can be of limited usefulness to the pharmacist. For instance, promotional offers that may be available to the patient from the manufacturer of a drug, for example, but not governed by or perhaps even known to the Authorizing Party 21 could be omitted from the original message. The contents of the original message may be limited to a simple “approved” or “prior authorization required” message, and can optionally be compliant with a standard promulgated by the National Council for Prescription Drug Programs (“NCPDP”), for example, or any other standardized communication protocol in the pharmacy industry. Similarly, the original claim submission can also optionally be transmitted in compliance with a standardized pharmacy industry communication protocol such as NCPDP, for example. If prior authorization is required, that message can optionally be accompanied by an encoded representation of the reason behind the requirement of prior authorization. For example, the original message shown in FIG. 2 includes the Pharmacy Reject Code 32, which is shown as rejection code “76”. Rejection codes provide a numerical representation of the reason for which an insurance claim is not approved in the response, and can be included in the information transmitted by the pharmacy terminal 18 to be delivered to the service provider 16. Rejection code 70, for instance, is issued to indicate that the product and/or service prescribed are/is not covered by the insurance plan identified in the script information. Rejection code 75 is issued to indicate that prior authorization is required for a variety of reasons such as the drug is new, or is not a preferred drug for treating a predetermined ailment/condition. Rejection code 76 is issued to indicate that the benefit limits of the insurance plan identified in the script information has been exceeded, also requiring manual, prior authorization from the Authorizing Party 21 before insurance coverage for the prescription drug can be approved.

Under such circumstances, when prior authorization is required the pharmacy terminal 18 can be programmed to transmit at least a portion of the information included in at least one of: the script information fields 24, the content resulting in the rejection notice 26, and the detail window 30 to the service provider computer 12. This is represented in FIG. 6 as communication “3. Message API request”. For example, the pharmacy computer terminal 18 can be programmed to forward such information to the service provider computer 12 in response to the failure on the part of the Authorizing Party 21 to approve insurance coverage for the drug, optionally also in response to a command entered by the pharmacist to the pharmacy terminal 18 initiating such a transmission. According to alternate embodiments, the pharmacy terminal 18 can be programmed to transmit such information received automatically, without human intervention, to the service provider computer 12. The server 20 can optionally be instructed to transmit such information to the service provider computer 12 according to alternate embodiments, but other methods of delivering such information to the service provider computer 12 are also encompassed by the present disclosure.

In response to receiving this information, the service provider computer 12 can utilize the information received over the communication network 14 to determine the context of the communication automatically, or optionally receive manually-entered information indicating the context of the communication. For example, the service provider computer terminal 12 can utilize the drug identity received as part of the “3. Message API request” received over the communication network 14 to determine whether a “Quick Start Voucher”, described below, is available for that drug and, if so, transmit an API response over the communication network 14 including this additional information to be presented to the pharmacist by the pharmacy terminal 18, optionally in combination with the contents of the original message. A database 17 (FIG. 1) of drugs for which a Quick Start Voucher is available can be stored in a computer readable medium provided to the service provider computer 12, or otherwise accessible by the service provider computer 12. The service provider computer 12 can optionally access the content of such a database without first communicating with the server 20. In other words, a determination of whether the Quick Start Voucher is available can be made by the service provider computer 12 independently of any communications between the service provider computer 12 and the server 20. If a Quick Start Voucher is available, the service provider computer 12 can transmit this availability to the pharmacy terminal 18 as part of the API Response in FIG. 6, and the pharmacy terminal 18 can then present an indication 36 of this availability to the pharmacist in the point of sale display 22, for example. For instance, selectable button 38 can also optionally be activated (e.g., changed from a grayed out state to an active state) based on the API Response, available for selection by the pharmacist, to commence the process for obtaining a Quick Start Voucher and requesting prior authorization for financial contribution toward the purchase price of the prescription drug. Thus, the Quick Start Voucher can be offered for redemption without a decision whether to grant the prior authorization from the Authorizing Party 21 (e.g., the Quick Start Voucher can be offered before such a decision is made and/or relayed to the pharmacy terminal 18, a decision that may remain pending after the offer to redeem the Quick Start Voucher has been accepted and the drug dispensed under the Quick Start Voucher). According to the present embodiment, the selectable button 38 is selectable to both obtain access to the Quick Start Voucher and commence the process for requesting prior authorization. In other words, the Quick Start Voucher is not redeemable or otherwise usable without also proceeding with the request for prior authorization since the Authorizing Party 21 indicated that prior authorization was required as the original message. For this example, the Quick Start Voucher cannot be utilized to circumvent the requirement of prior authorization.

The selectable button 38, and/or the Online Submission Interface window 28 can optionally be given an appearance or otherwise include content related to the context of the transaction as determined by the service provider computer 12 and conveyed to the pharmacy terminal as part of the API Response. For instance, continuing with the example of the Quick Start Voucher, the button 38 in FIG. 2 is customized, based at least in part on the additional information from the service provider computer 12, to read “Get Quick Start Voucher and Start PA”, indicating that selection of the button 38 will result in a process during which both the Quick Start Voucher can be redeemed and the necessary request for prior authorization can be submitted. This caption was generated for the button 38 because the response from the server 20 indicated prior authorization was required in this example, and the service provider computer 12 determined that a Quick Start Voucher was available. Likewise, the Online Submission Interface window 28 displayed by the pharmacy terminal 18 can optionally include text, a graphic, or any other content. The message shown in FIG. 2 as being conveyed in the Online Submission Interface window 28 can alternatively be presented as an audio and/or video clip. But regardless of the nature of the content presented by the pharmacy terminal 12 based on the API Response, that content can optionally be specific to at least one of: the drug, the drug form, the drug dose, a source of the drug, the reject claim code, and other content submitted to the service provider computer 12 as part of the Message API Request. According to other embodiments, the response from the Authorizing Party 21 can optionally formatted with a format known to the pharmacy terminal 18, optionally in a standardized data-interchange format. For such embodiments, the response, and optionally any other communication can include name and value pairings in bracketed strings, such as: {′button_{—} label′: ‘Submit’, ‘message’: “Submit your rejection to CoverMyMeds. And here is more additional message information from the PBM . . . }. Upon receiving such a string, the recipient computer can enter the values into predetermined locations of a display device and/or save the values in association with the patient and/or prescription information.

However, according to alternate embodiments, a plurality of separate buttons 38, each selectable to bring about a different result (e.g., one button selectable specifically to redeem a Quick Start Voucher (without also initiating the prior authorization process), and another button selectable specifically to initiate the prior authorization request independently of any actions concerning the Quick Start Voucher) can be provided. The content related to the context of the transaction as determined by the service provider computer 12 that is to appear linked to the button 38 can include any message pertaining to the prescription drug and/or insurance coverage (e.g., text, graphic, animation, symbol, audible message, etc.), and can change with each transaction to be specific to the context of the transaction.

A Quick Start Voucher grants the patient or would-be recipient of the prescription drug at the pharmacy a limited quantity, which can optionally be less than the full prescribed quantity, of the prescription drug as a stopgap measure to satisfy the patient's needs while awaiting prior authorization. For example, if the prescription was for a quantity of the prescription drug that would last, if taken as prescribed, thirty (30) days (e.g., a 30-day prescription of pills to be taken two per day would include 60 pills), the patient can be offered a 10-day sample of the prescription drug. As the name suggests, the 10-day sample includes a quantity of the prescription drug that, if taken by the patient as prescribed, would last only ten (10) days (e.g., a 10-day prescription of pills to be taken two per day would include 20 pills). For such embodiments, there would be no refills available unless the pharmacy first receives a decision from the Authorizing Party 21 granting prior authorization, and the pills dispensed would be the same as those prescribed (e.g., same brand name; same dose; same type such as liquid, tablet and the like; etc.). The use of more than one Quick Start Voucher for a given prescription can also be prohibited by noting redemption of a Quick Start Voucher in the patient's record in the database referenced to issue the notification 36 in the first place or any other database, such as that accessible by the pharmacy terminal 18, for example. According to such embodiments, the selectable button 38 can be rendered inactive to request redemption of a subsequent Quick Start Voucher while a prior authorization decision concerning the prescription for which another Quick Start Voucher has been redeemed is pending.

In the event prior authorization is later granted after a portion of the prescribed quantity of the drug is dispensed according to the Quick Start Voucher, the prescribed amount authorized can optionally be offset by the quantity dispensed based on the Quick Start Voucher to hold the patient over while the patient waited for the prior authorization decision. Thus, the total amount dispensed for the patient matches the quantity originally prescribed. According to other embodiments, the full prescribed amount can optionally be dispensed to the patient in addition to the quantity dispensed according to the Quick Start Voucher once prior authorization has been obtained by the pharmacy. Although the example above describes a 10-day quantity being dispensed under the Quick Start Voucher, the dispensed quantity can be substantially less, such as a three-day supply of the prescription drug depending on the time typically required for a prior authorization decision.

According to alternate embodiments, the first prescription, in its entirety, can optionally be offered as the limited quantity free of cost to the patient, at a reduced cost (e.g., less than standard retail) or at the retail cost, with subsequent refills being offered at a predetermined price (e.g., a discounted price from a standard purchase price, promotional price, regular retail price, etc.). The Quick Start Voucher grants the patient access to the prescribed drug while prior authorization for the full prescription is sought. The Quick Start Voucher can optionally be offered free of charge to the patient, at a reduced price that is less than the full retail price of the prescription drug for the quantity to be distributed under the Quick Start Voucher if paid for entirely out of pocket by the patient, or at the full retail price of the particular quantity of the drug to be distributed under the Quick Start Voucher (e.g., a pro-rated dollar amount corresponding to the quantity of the drug to be dispensed relative to the prescribed quantity). At least a portion of the cost of the limited quantity of the drug dispensed under the Quick Start Voucher can optionally be covered by the source or manufacturer (e.g., the pharmaceutical company) of the drug, regardless of whether prior authorization is ultimately granted.

The Quick Start Voucher can optionally be made available only in combination with a requirement that the request for prior authorization be submitted to the Authorizing Party 21, or can be made available apart from the requirement to obtain prior authorization. In other words, the Quick Start Voucher can be redeemed for the limited quantity of the prescription drug contingent upon the pharmacist also initiating the process for requesting prior authorization, which can also optionally be accomplished through selection of the same button 38. Selection of the button 38 can be transmitted to the service provider computer 12 as communication “5. COMMENCE REQUEST FOR PRIOR AUTHORIZATION AND REDEEM VOUCHER” in FIG. 6.

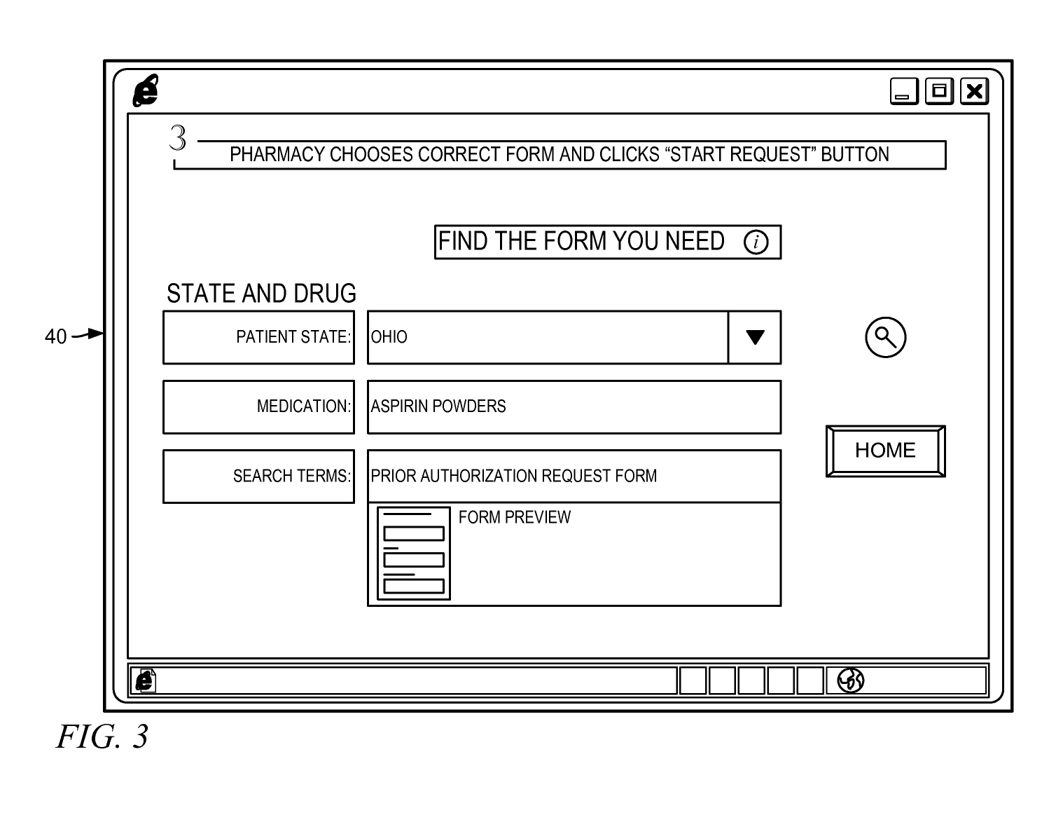

In response to receiving the communication transmitted by selection of the button 38, the service provider computer 12 transmits communication “6. SERVE CONTENT FOR REQUESTING PRIOR AUTHORIZATION” shown in FIG. 6. As shown in FIG. 3, the pharmacy terminal 18 can utilize this content to open a new window, optionally in a web browser such as Internet Explorer, for example, and display a form selection interface 40 therein in response to selection of the button 38. The process for requesting prior authorization can involve receiving, via the form selection interface 38, information pertaining to the state in which the patient resides, the drug that was prescribed, and any additional search terms entered by the pharmacist. This information can be transmitted over the communication network 14 to the service provider computer 12, which conducts a search for the proper form for requesting prior authorization in this particular instance using a search algorithm in conjunction with the received information entered by the pharmacist into the form selection interface 40. One, or a plurality of likely candidate forms returned by the search can be transmitted over the communication network 14 to be received by the pharmacy terminal 18, optionally allowing the pharmacist to make the final selection of the appropriate form to be requested to request prior authorization in this instance.

According to alternate embodiments, the most likely form (e.g., the best fit based at least in part on the script information, and optionally additional information about the patient such as state of residence) for requesting prior authorization can optionally be automatically returned by a search conducted in the background instead of opening the new window for entry of additional information. Alternately, one or a plurality of forms that exceed a predetermined threshold probability of being the appropriate form can be returned by the search performed in the background, optionally to be presented to the pharmacist and for final selection.

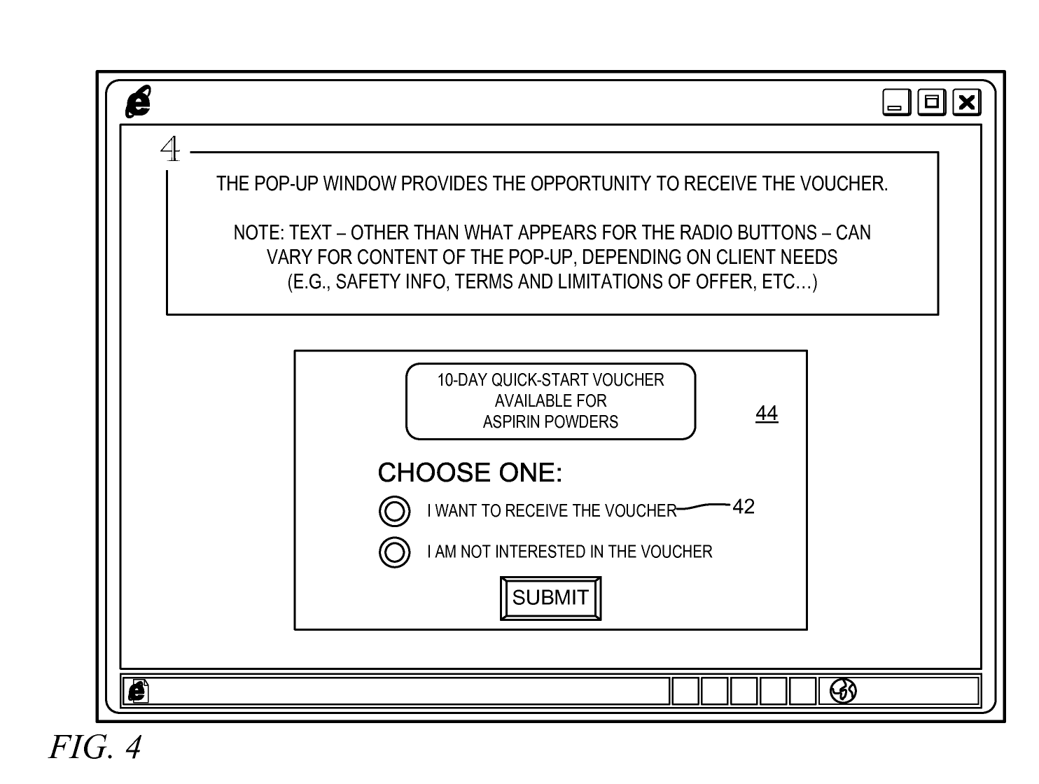

At some point during the request process, such as in response to the entry of confirmation that the form returned by the search is the correct form, or before or after the pharmacist completes the form requesting prior authorization, but before the form is submitted as part of the request for prior authorization, or even after the request for prior authorization has been finalized and submitted, or at any other time during the workflow, the pharmacy terminal 18 can present the display appearing in FIG. 4 to the pharmacist, allowing the pharmacist to select an option 42 from the menu 44, for example, to indicate a desire on the part of the patient or other recipient to redeem the Quick Start Voucher and obtain the limited quantity of the prescription drug. Such a transmission, indicated in FIG. 6 as communication “7. ELECTION TO RECEIVE VOUCHER AND PRIOR AUTHORIZATION INFORMATION” in FIG. 6, conveys the pharmacist's desire to redeem a Quick Start Voucher and sends the information entered into the prior authorization form in FIG. 3 to be received by the service provider computer 12 and subsequently sent to the Authorizing Party 21. The process for completing the appropriate form and submitting the completed form for requesting prior authorization can be similar to the process described in detail in U.S. patent application Ser. No. 13/413,231 to Scantland et al., which is incorporated in its entirety herein by reference above.

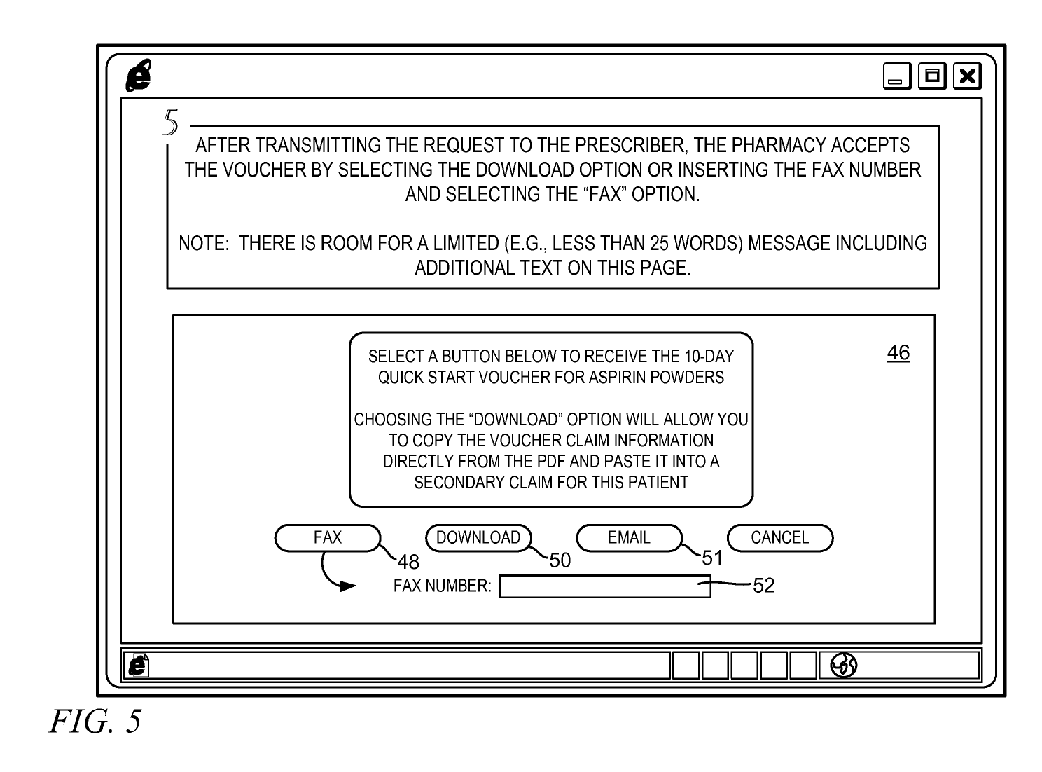

If the option 42 is selected from the menu 44 of FIG. 4, content is transmitted over the communication network 14 from the service provider computer 12, the server 20 or other source to be received by the pharmacy terminal 18, enabling the pharmacy terminal 18 to display a redemption window 46 such as that shown in FIG. 5. The redemption window 46 can optionally be displayed to allow the pharmacist to obtain the Quick Start Voucher only after the request for prior authorization has been submitted, but as explained above, redemption of the Quick Start Voucher or other utilization of additional information supplementing the original message can be permitted independent of whether prior authorization is ultimately requested. The embodiment of the redemption window 46 shown in FIG. 5 includes a fax option 48, a download option 50, and an email option 51, but other embodiments can include options that allow the pharmacist to obtain the Quick Start Voucher using any other desired delivery options. The fax option 48 is selectable by the pharmacist to request that the Quick Start Voucher be transmitted via facsimile to the pharmacy by a party (e.g., the service provider 16, pharmacy benefits manager or other Authorizing Party 21, pharmaceutical company who manufactures the drug, insurance plan, etc.) authorized to distribute the Quick Start Vouchers. The pharmacist is required to enter a facsimile number into a fax number field 52 that the sender can dial to transmit the Quick Start Voucher via facsimile. Similarly, selection of the email option 51 displays a fillable email field, similar to the fax number field 52, in which the user enters the email address to which the Quick Start Voucher is to be sent. The download option 50, if selected, initiates transmission of the Quick Start Voucher in an electronic format, such as a pdf document for example, over the communication network 14 to be displayed and optionally printed by the pharmacist using the pharmacy terminal 18.

Regardless of how the Quick Start Voucher is received, the voucher can optionally be issued in limited quantities. The limit can be imposed on the total number of Quick Start Vouchers allowed to be issued per pharmacy, market, or overall. Alternately, the Quick Start Vouchers can be limited to one, or a plurality per patient, optionally for a predetermined time period (e.g., one per patient during any given calendar year). According to alternate embodiments, the Quick Start Voucher can optionally be limited for redemption after submission of an insurance claim for at least partial coverage of the prescription drug cost resulting in an original response that prior authorization will be required, and before a decision on that prior authorization is conveyed to the pharmacy.

In furtherance of limiting the number of Quick Start Vouchers that can be redeemed, each Quick Start Voucher can be uniquely labeled, such as with a unique identification number. When the Quick Start Voucher is redeemed, its identification number may be required to be entered so it can be recorded by the pharmacy terminal 18 and/or computer memory accessible by the pharmacy terminal 18, by the service provider computer 12 and/or a computer memory accessible by the service provider computer 12, by the server 20 or a computer memory accessible by the server 20, by a server affiliated or maintained on behalf of a pharmaceutical company who granted the Quick Start Voucher, and/or any other party and/or other storage location designated for validating Quick Start Vouchers being redeemed, and limiting redemption to the predetermined number of Quick Start Vouchers that are available to be redeemed. Any additional attempts to redeem a Quick Start Voucher assigned an identification number that has already been redeemed will be denied.

Although the communication of notifications about the availability and delivery of a Quick Start Voucher is described herein as electronic, via the communication network 14, other methods of communicating the notifications and Quick Start Voucher are also encompassed by the present disclosure. For example, requests for prior authorization can optionally be transmitted from the pharmacy via facsimile.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of allowing a limited fulfillment of a prescription for a drug, the method comprising:
with a computer, receiving an indication over a communication network that an authorizing party has rejected an insurance claim submitted by a pharmacy for insurance coverage of at least a portion of a purchase price of a prescription drug on behalf of a patient;
receiving, with the computer, a communication indicating that the authorizing party requires prior authorization of the insurance coverage as a condition to complete fulfillment of the prescription, as prescribed by a physician licensed to practice medicine;
before a decision whether to grant the prior authorization is issued by the authorizing party, initiating transmission of an offer to allow redemption of a quick start voucher to the pharmacy over the communication network, wherein the quick start voucher is redeemable for at least partial cost coverage of the prescription for the prescription drug on behalf of the patient without the decision whether to grant the prior authorization; and
receiving prior authorization information that is to be included in a prior authorization form as part of a request for prior authorization in addition to redemption of the quick start voucher.

2. The method of claim 1, wherein the indication received is transmitted by the pharmacy after the pharmacy received an original message rejecting the insurance claim and notifying the pharmacy that prior authorization is required.

3. The method of claim 1, wherein the prior authorization is required as a result of a determination that a formulary alternative to the drug that was prescribed is available.

4. The method of claim 1, wherein the cost coverage is included as part of a limited fulfillment that is less than the complete fulfillment of the prescription, and the quantity of the drug to be dispensed as the limited fulfillment of the prescription comprises a first quantity that is less than a prescribed quantity of the drug.

5. The method of claim 4, wherein the first quantity comprises a ten (10) day supply of the drug or less.

6. The method of claim 5, wherein the first quantity comprises a three (3) day supply of the drug or less.

7. The method of claim 1 further comprising limiting a number of the quick start vouchers redeemable for the patient to one.

8. The method of claim 1 further comprising linking the redemption of the quick start voucher to submitting a request for the prior authorization, requiring submission of the request for prior authorization as a condition to the redemption of the quick start voucher.

9. The method of claim 8 further comprising:
receiving, over the communication network, a response that the redemption of the quick start voucher is desired; and
in response to said receiving, initiating generation of a prior authorization form to be submitted as part of the request for prior authorization.

10. The method of claim 9, wherein the prior authorization information comprises:
receiving drug information that identifies the drug;
receiving plan information that identifies at least one of an insurance plan of the patient and a provider of the insurance plan;
initiating a search of a database to identify the prior authorization form from a plurality of different prior authorization forms using a search algorithm in conjunction with the drug information and the plan information received; and
transmitting the prior authorization form over the communication network to be received by the pharmacy terminal.

11. The method of claim 9 further comprising transmitting the quick start voucher over the communication network to be received by the pharmacy.

12. The method of claim 1, wherein the quick start voucher is redeemable to allow the pharmacy to dispense the quantity of the drug without any out of pocket contribution by, or on behalf of, the patient.

13. The method of claim 1, wherein the offer to allow redemption of the quick start voucher is transmitted in response to receiving at least one of a plurality of different reject codes that have been predetermined as triggering transmission of the offer.

14. The method of claim 1, wherein said initiating transmission of the offer to allow redemption of the quick start voucher comprises transmitting correspondence comprising terms of the quick start voucher to be delivered to the physician for approval.

15. The method of claim 1, wherein the cost coverage is limited to an amount that is less than a total cost of the prescription for the prescription drug.

16. A method of fulfilling a prescription for a drug, the method comprising:
with a computer, submitting an insurance claim for at least partial insurance coverage of the drug under an insurance plan on behalf of a patient;
receiving an indication over a communication network that an authorizing party has rejected the insurance claim and requires prior authorization of the insurance coverage as a condition to the insurance coverage of a quantity of the drug to be dispensed in complete fulfillment of the prescription, as prescribed by a physician licensed to practice medicine;
transmitting a communication to a service provider computer over a communication network to indicate that the prior authorization has been required by the authorizing party;
in response to said transmitting, and before receiving a decision concerning the prior authorization from the authorizing party, receiving an offer comprising a quick start voucher over the communication network, the quick start voucher being redeemable for at least partial cost coverage of the prescription for the drug on behalf of the patient without the decision whether to grant the prior authorization from the authorizing party; and
in addition to communicating a decision to redeem the quick start voucher, transmitting prior authorization information that is to be included in a prior authorization request for submission with the authorizing party.

17. The method of claim 16 further comprising receiving the decision to grant prior authorization from the authorizing party after the drug has been dispensed to be administered to the patient as a result of redemption of the quick start voucher.
